(19) United States
(12) Patent Application Publication
(10) Pub. No.: US 2010/0302927 A1
(43) Pub. Date: Dec. 2, 2010

(54) OPTICAL DATA STORAGE MEDIUM AND METHODS FOR USING THE SAME

(75) Inventors: Arunkumar Natarajan, Schenectady, NY (US); Eugene Pauling Boden, Scotia, NY (US); Kwok Pong Chan, Troy, NY (US); David Gilles Gascoyne, Niskayuna, NY (US); Evgenia Mikhailovna Kim, Ballston Lake, NY (US); Brian Lee Lawrence, Niskayuna, NY (US); Victor Petrovich Ostroverkhov, Ballston Lake, NY (US); Robert James Perry, Niskayuna, NY (US); Michael Teruki Takemori, Rexford, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, Schenectady, NY (US)

(21) Appl. No.: 12/475,534

(22) Filed: May 31, 2009

(51) Int. Cl. G11B 7/00; B32B 9/04; B32B 27/30; B32B 27/28

(52) U.S. Cl. 369/103; 428/704; 428/412; 428/500; G9B/7

(57) ABSTRACT

There are provided an optical data storage medium and methods of optical data storage using the same. The optical data storage medium comprises a non-linear sensitizer capable of absorbing actinic radiation to cause upper triplet energy transfer to a reactant that undergoes a photochemical change upon triplet excitation.

### BACKGROUND

The present disclosure relates to optical data storage media, and more particularly, to holographic storage mediums as well as methods of making and using the same.

The rapid growth of information technology industry has led to an increasing demand for data storage systems. Optical data storage, wherein reading or writing of data is accomplished by shining light on, e.g., a disk, provides advantages over data recorded in media which must be read by other means, e.g., a magnetically sensitive head for reading magnetic medium, or a needle for reading media recorded in vinyl. More particularly, more data can be stored in smaller media optically than can be stored vinyl media, and, since contact is not required to read the data, optical media are not as vulnerable to deterioration over periods of repeated use as vinyl media. Compared to a magnetic storage, the optical data storage media also offer multiple advantages. Unlike the magnetic disk drives, optical storage systems are most commonly made as removable media, readily suitable for archiving and backing up data, easy sharing of content between unconnected systems, as well as distribution of prerecorded content. Magnetic tapes are one of the most common removable media used for archival and back-ups, however the life-time of information stored on tape is limited to 10-12 years, the drives are generally rather expensive, and data access is slow. In contrast, optical storage systems combined flexibility of removable recordable and/or prerecorded medium, fast data access time, robust inexpensive manufacturing of the media and drives that are affordable enough for consumer computer and entertainment systems.

Nonetheless, optical data storage does have limitations. First, the storage density of optical media is limited by physical constraints on the minimum size of a recording bit. Another limitation of optical storage is that data is usually stored on the surface of the medium only. One way of increasing the storage capacity of optical media is to record the information depth-wise, i.e., producing marks in three rather than two, dimensions, thereby providing very high capacity storage systems. Bleaching and photoreactions, e.g., photochromicity, have been used as a means to record optical data in three dimensions. However, these require a large amount of optical power to produce readable marks, and as a result, the rate of recording using bleaching or photoreactions is slow. Photochromic systems with a linear response to the recording light energy require some mechanism to eliminate the sensitivity of the medium to light after the data have been recorded to eliminate unintended erasure and data loss due to the ambient exposure or light recording information into adjacent volumes of the medium.

Holographic storage is data storage in which the data is represented as holograms, which are images of three dimensional interference patterns created by the intersection of two beams of light in a photosensitive medium. More particularly, the superposition of a reference beam and a signal beam, containing digitally encoded data, forms a 3-D interference pattern within the volume of the medium resulting in a chemical reaction that changes or modulates the refractive index of the photosensitive medium. This modulation serves to record as the hologram both the intensity and phase information from the signal. The hologram can later be retrieved by exposing the storage medium to the reference beam alone, which interacts with the stored holographic data to generate a reconstructed signal beam proportional to the initial signal beam used to store the holographic image.

Early attempts at holographic storage relied on a page-based approach, i.e., where the bits of digital information are encoded into volume holograms as two-dimensional arrays of logical zeros and ones that traversed a ‘slice’ of the necessarily linear media onto which the holograms were recorded. Because a relatively large volume on the media was utilized, the recording and read-out equipment required to utilize a page based approach can be complex and expensive, and the media tends to be susceptible to damage or unreliable performance when exposed to fluctuations in temperature, vibration and variations in writing or reading wavelength or intensity.

As a result of these shortcomings, more recent research into holographic data storage has focused on a bit-wise approach, where each bit (or few bits) of information is represented by a hologram localized to a microscopic volume within the medium to create a region that reflects the readout light. Such localized volume holographic micro-reflectors may be arranged into multiple data layers throughout the volume of the medium. In such arrangement, the readout and recording of data in the layers inevitably leads to exposure of the adjacent layers to the recording/readout radiation, and so, linear media cannot typically be used in this type of holographic data storage approach. Nonetheless, materials capable of accommodating a bit-wise data storage approach is highly sought after as the equipment utilized to read and write to such material is either currently commercially available, or readily provided with simply modifications to readily commercially available reading and writing equipment. Further, holographic data storage by the bit-wise approach is more robust to temperature, wavelength, intensity variations, and vibration than holographic data stored using the page-based approach.

Thus, there remains a need for optical data storage media with threshold response to the recording light intensity that is suitable for bit-wise holographic data storage. In particular, it would be advantageous for holograms stored in the media to be limited in depth so that increased capacity could be realized. It would be further desirable for such data storage media to be written in such a way that refractive index of the surrounding media is not significantly altered and that a substantial degradation of hologram efficiency at increasing depths is not seen.

### BRIEF DESCRIPTION

An optical data storage medium is provided. The medium comprises a polymer matrix, a reactant capable of undergoing a photochemical change upon triplet excitation (Tₙ;>1) and a non-linear sensitizer capable of absorbing actinic radiation to cause upper triplet-to-triplet energy transfer to said reactant.

Also provided is an optical data storage medium comprising a polymer matrix, a reactant comprising a stilbene derivative and capable of undergoing a photochermical change upon triplet excitation and a non-linear sensitizer comprising a reverse saturable absorber capable of absorbing actinic radiation to cause upper triplet-to-triplet energy transfer to said reactant.

Also provided are methods for optical data storage. The methods comprise providing an optical data storage medium comprising a sensitizer and a reactant. The reactant is capable of undergoing a photochernical change upon triplet excitation and a non-linear sensitizer capable of absorbing actinic radiation to cause upper triplet-to-triplet energy transfer to said reactant.

### DRAWINGS

These and other features, aspects, and advantages of the present invention will become better understood when the following detailed description is read with reference to the accompanying drawings in which like characters represent like parts throughout the drawings, wherein:

FIG. 1A is a graphical depiction of the response of a linear sensitizer to actinic radiation;

FIG. 1B is a graphical depiction of the response of a threshold sensitizer to actinic radiation;

FIG. 2 is a cross-sectional view of an optical storage media, showing the area of impact of actinic radiation if the media comprises a linear sensitizer and the area of impact of actinic radiation if the media comprises a threshold sensitizer;

FIG. 3 is a schematic energy level diagram showing the upper triplet Tₙ excited state absorption and resulting energy transfer for a sensitizer exhibiting reverse saturable absorption;

FIG. 4A is a graphical depiction of conversion efficiency as a function of pulse energy of polymer-bounded stilbene samples (Examples 1 & 2) sensitized by indium and zinc phthalocyanine RSA dyes;

FIG. 4B is a graphical depiction of conversion efficiency as a function of pulse energy of stilbene doped PMMA samples (Examples 3 & 4) sensitized by indium phthalocyanine RSA dye with and without benzophenone as mediator; and

FIG. 5 is a graphical depiction of micro (μ)-hologram reflectivity vs. recording pulse energy in one embodiment of the optical data storage media.

### DETAILED DESCRIPTION

Unless defined otherwise, technical and scientific terms used herein have the same meaning as is commonly understood by one of skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement of the particular quantity).

There is provided herein optical data storage media suitable for recording microholographic data in a bit-wise approach. The media desirably exhibits a nonlinear response to actinic radiation, i.e., experiences no change in refractive index for incident laser light below a threshold, and significant changes in refractive index above the threshold. Advantageously, while recording into such a medium is only possible with the light having a power, or fluence, exceeding a threshold value, and the recorded data can be repeatedly and substantially non-destructively read with light having a fluence below the threshold. Microholograms recorded in the present optical data storage media are expected to be smaller in size than the beam used to record them.

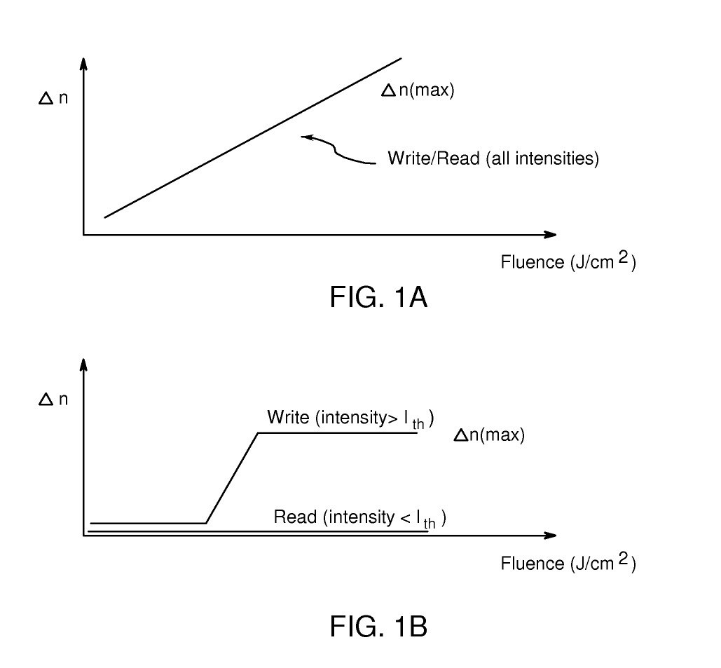

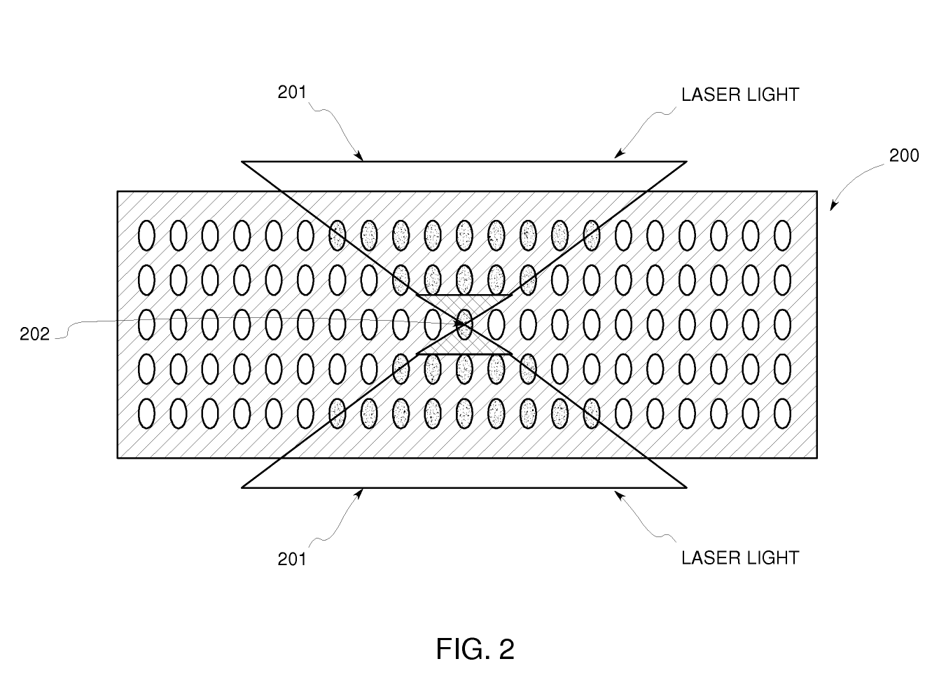

The optical data storage media comprises a non-linear sensitizer and a reactant dispersed within a polymer matrix. The non-linear sensitizers utilized in the optical data storage media provided herein are capable of absorbing incident actinic radiation and then transferring the energy to the reactant molecule to induce a molecular rearrangement of the reactant to a product that, in turn, gives rise to modulations in the refractive index of the medium. This modulation serves to record as the hologram both the intensity and phase information from the incident actinic radiation. The advantages of the use of threshold sensitizers as opposed to linear sensitizers can be further understood with references to FIGS. 1A, 1B, and 2.

More specifically, FIG. 1A shows the response of a linear sensitizer to incident actinic radiation, while FIG. 1B shows the response of a threshold sensitizer to incident actinic radiation. As is shown in FIG. 1A, linear sensitizers will cause a reaction at any power density (fluence) of recording light and the amount of the refractive index change (Δn) achieved will be the same for the same radiative energy flux (fluence) received by the material. In contrast, a threshold sensitizers will only cause a reaction at and over a certain light intensity of recording light.

As a result, and as is shown in FIG. 2, in data storage media 200 comprising linear sensitizers, consumption of dynamic range will occur in non-addressed volumes, substantially everywhere actinic radiation passes through, shown as sections 201. In contrast, if data storage media 200 comprises threshold sensitizers, consumption of dynamic range in non-addressed volumes is reduced or eliminated and consumption will occur substantially only in the target volume, i.e., at the focal point 202 of the actinic radiation. The use of threshold sensitizers in the present optical data storage medium thus facilitates recording into a layer of bit-wise data buried in the bulk of the medium without disruption of adjacent layers of previously recorded data or vacant space available for subsequent recording. Also, as the light intensity in a tightly focused laser beam varies dramatically through the depth of the focal spot and is usually at its maximum at the beam waist (narrowest cross section), the threshold response of the medium will naturally restrict material conversion to occur only in the immediate vicinity of the beam waist. This may lead to a reduction in microhologram size within each layer, thus facilitating an increase in layer data storage capacity of the present media, so that the overall data storage capacity of the media may also be increased. The data storage media will also advantageously be substantially stable in ambient light, so that exposure to the same does not result in substantial deterioration or damage to the media.

The non-linear sensitizers used in the present optical data storage media are capable of transferring energy from an upper triplet state (T_{n,} wherein n>1), which has a very short lifetime (nanoseconds to a few μ (micro) seconds), to the reactant. The ability to transfer energy from the Tₙ state provides the optical storage media provided herein with its threshold properties. That is, Tₙ excited state absorption is only appreciable when the sensitizer is excited by high-intensity light, and negligibly small when excited by low-energy radiation. This allows for the present optical data storage media, comprising the non-linear sensitizers, to remain substantially transparent and inert to low intensity radiation, e.g., reading or ambient light, and to only change its properties (absorbance and thus, refractive index) in response to high energy recording light, e.g., light having an intensity at least 2 orders of magnitude or more greater than ambient light. As a result, the present optical data storage media exhibits the threshold behavior desired and/or necessary for the bit-wise recordation of microholographic data.

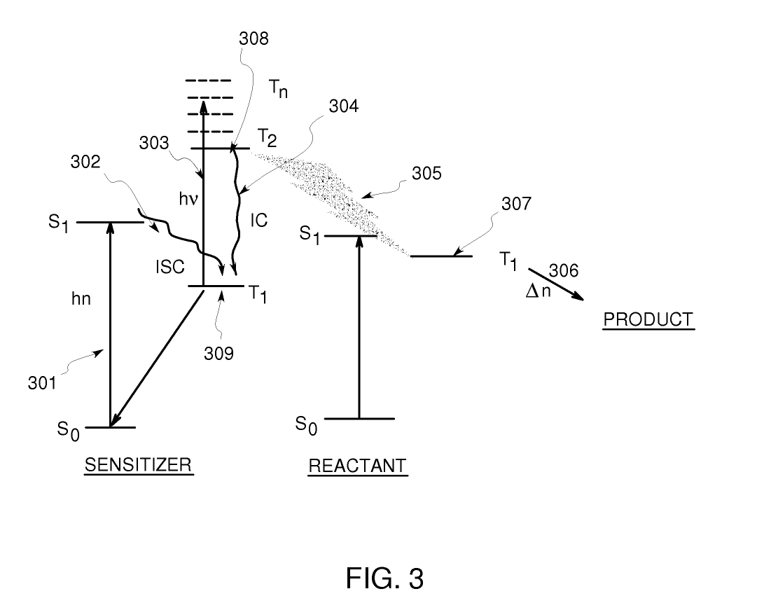

FIG. 3 is a schematic energy level diagram showing the upper triplet Tₙ excited state absorption and resulting energy transfer for a sensitizer exhibiting reverse saturable absorption. As shown in energy level diagram 300, arrow 301 illustrates the ground state absorption cross section of a photon as it transitions from the singlet ground state S₀ to a first excited state S_{1.} The intersystem-crossing rate, represented by arrow 302, signifies the transfer of energy that occurs when the sensitizer moves from an excited singlet state S₁ to a corresponding triplet state T_{1.} Arrow 303 indicates the excited triplet state absorption cross section. Once the upper level triplet state Tₙ is achieved by subsequent linear absorption, two upper excited decay processes are possible. One possible decay process, denoted by arrow 304 in FIG. 3, is the non-radiative relaxation by internal conversion (IC) to the lower lying T₁ state. The other possible decay process is denoted by arrow 305 in FIG. 3, and involves the release of energy from the sensitizer and the transfer of this energy to the reactant via Triplet-Triplet Energy Transfer. The reactant then undergoes a photochemical reaction denoted by arrow 306 to alter the holographic grating and record the data there.

In one embodiment, the non-linear sensitizers comprise molecules which exhibit reverse saturable absorption (RSAs). Examples of RSAs include metal/ligand complexes, such as phthalocyanines, naphthalocyanines or porphyrins; fullerenes; or transition metal cluster compounds. These, and other examples of RSAs suitable for use in the present optical data storage media are disclosed in Perry et al., “Enhanced reverse saturable absorption and optical limiting in heavy atom-substituted pthalocyanines”, optics Letters, May 1, 1994, Vol. 19, No. 9, pages 625-627, hereby incorporated by reference herein in its entirety. Of course, these are exemplary, and many more varieties of reverse saturable absorbing molecules, or any other molecules exhibiting non-linear absorption, may be used in the optical data storage media disclosed herein.

Desirably, the RSAs will be capable of entering into the upper triplet (T₂) state upon photoexcitation of the RSA with incident actinic radiation at a wavelength of about 532 nm RSAs that are particularly advantageously utilized in the present optical data storage media include phthalocyanines and porphyrins, and in particular those comprising indium, lead copper or zinc. Preferred phthalocyanines include, for example, lead(II)tetrakis(4-cumylphenoxy)phthalocyanine, copper(II)tetrakis(4-cumylphenoxy)pthalocyanine, zinc 2,9,16,23-tetra-tert-butyl-29H, 31H-phthalocyanine or indium 2,9,16,23-tetra-tert-butyl-29H-31H-phthalocyanine. Additionally, the dyes include phthalocyanine and porphyrin based RSA dyes with metals (transition metals, group IIA-VIA metals, rare earth metals), and triplet yields of greater than about 0.2 and whose T₂ lifetime is greater than or equal to about 20 nanoseconds.

The amount of sensitizer used in the optical data storage media can depend on its optical density at the wavelength of light used to record the hologram. Solubility of the sensitizer may also be a factor. Generally speaking, the sensitizer may be used in an amount of from about 0.002 weight % to about 5 weight % based upon the total weight of the data storage media.

The sensitizer may be covalently attached, or otherwise associated with, the polymer matrix. For example, polymers having a stilbene unit may be utilized as the polymer matrix, and many polyesters, polycarbonates and polyacrylates are known that include such stilbene units, or the same can be functionalized to include stilbene units. In this case, or in the case of a sensitizer having a low extinction coefficient, the sensitizer may optionally be utilized at higher levels, e.g., from about 0.01 weight % to about 20 weight %, based upon the total weight of the optical data storage media.

In some embodiments, photostabilizers may also be included in the optical data storage media described herein, in order to assist in the photostabilization of the non-linear sensitizer utilized therein. Those of ordinary skill in the art are aware of compounds/materials useful for this purpose, and useful amounts of these, and any of these may be used, in any suitable amount. One exemplary compound that may assist in the photostabilization of, e.g., a phthalocyanine dye, includes bisdithiobenzil nickel.

The reactants utilized in the present optical data storage media are capable of undergoing a photochemical change upon triplet excitation. More particularly, and referring again to FIG. 3, the reactants used in the present optical data storage media have a triplet energy denoted by arrow 307 below that of the T₂ state of the sensitizer denoted by arrow 308, but above that of the T₁ state of the sensitizer, shown at arrow 309. The reactants are also capable of receiving energy from an upper triplet state (T₂) of the sensitizer, and undergoing a photochemical reaction to a product, which provides a refractive index change within the polymer matrix and thus, a recorded hologram.

Any reactant having a triplet energy state between the T₁ and T₂ states of the sensitizer can be utilized, and, selection of an appropriate reactant can thus depend upon the selection of the desired sensitizer. Suitable reactants include, but are not limited to, stilbenes and indole stilbenes. Specific examples of stilbenes expected to be useful in the optical storage media disclosed herein include, but are not limited to trans-stilbene, meta- (or) para halogen (F, Cl, Br, or I) substituted stilbene, meta- (or) para methylstilbene[meta- (or) para]-aminostilbene, trans-[meta- (or) para]nitrostilbene, trans-[meta- (or) para]cyanostilbene, trans-[meta- (or) para]-methoxystilbene, [3,3′] or [4,4′], or [2,4] or [3,4]dimethoxy, dinitro, diamino, difluoro, dibromo, dichloro, diiodo, dicyano substituted trans-stilbenes, 2,4,6-trimethylstilbene, 2,2′,4,4′,6,6′-hexamethylstilbene, 4-benzoylstilbene, α-methylstilbene, α,β-di(F, Cl, Br or I) substituted stilbene, (E)-N,N-dimethyl-4(4nitrostyryl)aniline, E-1-styrylnapthalene, E-1-(4fluoro, bromo, chloro, or iodo) substituted styrylnapthalene, (Z)-2-(2-pyridin-2-yl)vinyl)-1H-indole, or combinations of these.

Even more specifically, suitable reactants include (E)-1-methoxy-4-styrylbenzene, (E)-1-nitro-4-styrylbenzene, (E)-1-fluoro-4-styrylbenzene, (E)-1-chloro-4-styrylbenzene, (E)-1-bromo-4-styrylbenzene, (E)-1-iodo-4-styrylbenzene, (E)-1-arnino-4-styrylbenzene, (E)-1-methoxy-3-styrylbenzene, (E)-1-fluoro-3-styrylbenzene, (E)-1-chloro-3-styrylbenzene, (E)-1-bromo-3-styrylbenzene, (E)-1-iodo-3-styrylbenzene, (E)-1-amino-3-styrylbenzene, (E)-1-cyano-4-styrylbenzene, (E)-N,N-dimethyl-4-styrylaniline, (E)-N,N-dimethyl-3-styrylaniline.

Yet other suitable reactants include (E)-1,2-bis(4-methoxyphenyl)ethene, (E)-1,2-bis(4-nitrophenyl)ethene, (E)-1,2-bis(4-fluorophenyl)ethene, (E)-1,2-bis(4-chlorophenyl)ethene, (E)-1,2-bis(4-bromophenyl)ethene, (E)-1,2-bis(4-iodophenyl)ethene, (E)-1,2-bis(3-methoxyphenyl)ethene, (E)-1,2-bis(3-fluorophenyl)ethene, (E)-1,2-bis(3-chlorophenyl)ethene, (E)-1,2-bis(3-bromophenyl)ethene, (E)-1,2-bis(3-iodophenyl)ethene, (E)-1,2-bis(3-cyanophenyl)ethene, (E)-4,4′-(ethene-1,2-diyl)dianiline, (E)-3,3′-(ethene-1,2-diyl)dianiline, and (E)-2,2′-(ethene-1,2-diyl)dianiline.

Still other suitable reactants include (E)-1-methoxy-2-(4-methoxystyryl)benzene, (E)-1-nitro-2-(4-nitrostyryl)benzene, (E)-1-fluoro-2-(4-fluorostyryl)benzene, (E)-1-chloro-2-(4-chlorostyryl)benzene, (E)-1-bromo-2-(4-bromostyryl)benzene, (E)-1-iodo-2-(4-iodostyryl)benzene, (E)-1-iodo-2-(4-cyanostyryl)benzene, (E)-1-methoxy-3-(4-methoxystyryl)benzene, (E)-1-fluoro-3-(4-fluorostyryl)benzene, (E)-1-chloro-3-(4-chlorostyryl)benzene, (E)-1-bromo-3-(4-bromostyryl)benzene, (E)-1-iodo-3-(4-iodostyryl)benzene, (E)-1-iodo-3-(4-cyanostyryl)benzene, (E)-1-methoxy-2-(3-methoxystyryl)benzene, (E)-1-fluoro-2-(3-fluorostyryl)benzene, (E)-1-chloro-2-(3-chlorostyryl)benzene, (E)-1-bromo-2-(3-bromostyryl)benzene, (E)-1-iodo-2-(3-iodostyryl)benzene, (E)-1-iodo-2-(3-cyanostyryl)benzene, (E)-2-(4-aminostyryl)aniline, (E)-2-(4-(dimethylamino)styryl)-N,N-dimethylaniline, (E)-3-(4-aminostyryl)aniline, (E)-3-(4-(dimethylamino)styryl)-N,N-dimethylaniline, (E)-2-(3-aminostyryl)aniline, (E)-2-(3-(dimethylamino)styryl)-N,N-dimethylaniline, 2-[(Z)-2-(pyridine-2-yl)ethenyl]-1-H-indole, 2-[(E)-2-(1H-pyrrol-2-yl)ethenyl]pyridine, and 2-[(E)-2-(pyridine-2-yl)ethenyl]-1-H-benzimidazole.

The reactant is usually present in relatively high concentrations both to yield large changes in optical properties within the polymer matrix and to promote more efficient triplet energy transfer. For example, the reactant may be present in the optical data storage media in amounts of from about 2 weight % to about 80 weight %, based upon the total weight of the optical data storage media.

Optionally, the data storage media may further comprise a mediator to assist in upper triplet energy transfer from the sensitizer to the reactant. The triplet state (T₁ₘ) of the mediator will desirably be (a) below the triplet state (Tₙ; n>1) of the sensitizer but above the T₁ of the sensitizer and (b) above the triplet state (T₁ᵣ) of the reactant, or between about 50 kcal/mol and 90 kcal/mol.

Examples of suitable mediators include, but are not limited to, acetophenone (T₁≈78 kcal/mol), dimethylphthalate (T₁≈73 kcal/mol), propiophenone (T₁≈72.8 kcal/mol), isobutyrophenone (T₁≈71.9 kcal/mol), cyclopropylphenylketone (T₁≈71.7 kcal/mol), deoxybenzoin (T₁≈71.7 kcal/mol), carbazole (T₁≈69.76 kcal/mol), diphenyleneoxide (T₁≈69.76 kcal/mol), dibenzothiophene (T₁≈69.5 kcal/mol), 2-dibenzoylbenzene (T₁≈68.57 kcal/mol), benzophenone (T₁≈68 kcal/mol), polyvinylbenzophenone (T₁≈68 kcal/mol), 1,4-diacetylbenzene (T₁≈67.38 kcal/mol), 9H-fluorene (T₁≈67 kcal/mol), triacetylbenzene (T₁≈65.7 kcal/mol), thioxanthone (T₁≈65.2 kcal/mol), biphenyl (T₁≈65 kcal/mol), phenanthrene (T₁≈62 kcal/mol), phenanthrene (T₁≈61.9 kcal/mol), flavone (T₁≈61.9 kcal/mol), 1-napthonirile (T₁≈57.2 kcal/mol), poly (β-naphthoylstyrene) (T₁≈55.7 kcal/mol), Fluorenone (T₁≈55 kcal/mol), and combinations of these.

If utilized, the mediator may, if desired, be covalently attached to, or otherwise associated with, the polymer matrix. Incorporating the mediator into the polymer matrix in this way can allow for higher concentrations of the mediator to be utilized, which, in turn, can increase recording efficiency of the data storage media.

The amount of mediator used, if any, should not be so much as to cause self-quenching, i.e., when two triplets of the mediator meet each other to generate a singlet state and a ground state of the mediator. Optimal amounts of any mediator may also depend on the particular sensitizer. Bearing such considerations in mind, useful concentrations of the mediator can range from about 1 weight % to about 20 weight % if dispersed within the polymer matrix, and from about 2 weight % to about 50 weight % if covalently attached to the polymer matrix.

The desired sensitizer and reactant may be substantially uniformly dispersed through a polymer matrix, or may be dispersed in any fashion so that bit-wise data recordation is facilitated within the medium. The polymer matrix may comprise a linear, branched or cross-linked polymer or co-polymer. Any polymer may be used so long as the sensitizer and reactant can be substantially uniformly dispersed therein. Further, any polymer utilized will desirably not substantially interfere with the upper triplet energy transfer process. The polymer matrix may desirably comprise a polymer that is optically transparent, or at least has a high transparency at the wavelength contemplated for recording and reading the optical data storage medium.

Particular examples of suitable polymers for use in the polymer matrix include, but are not limited to, poly(alkyl methacrylates), such as poly(methyl methacrylate) (PMMA), poly(alkyl acrylates), polystyrenes, polycarbonates, poly acrylates, poly(vinylidene chloride), poly(vinyl acetate), and the like. As mentioned above, the sensitizer may also be covalently attached, or otherwise associated with, the polymer matrix. For example, polymers such as polyesters, polycarbonates and polyacrylates including stilbene are readily available, or, are readily functionalized to include stilbene units.

The polymer matrix may also contain a plasticizer, such as dibutyl phthalate, dibutyl sebacate or di(2-ethylbexy) adipate. Plasticizers can enhance recording efficiencies by facilitating molecular motion. Typical plasticizer levels can range from about 1 weight % to about 20 weight %, based upon the total weight of the storage media, or from about 2 weight % to about 10 weight %.

The optical data storage media described herein may be in a self-supporting form. Or, the data storage media may be coated onto a support material, such as poly(ethylene terephthalate), poly(ethylene naphthalate), polystyrene, or cellulose acetate. Inorganic support materials such as glass, quartz or silicon may also be used, in those embodiments wherein use of a support material may be desired.

In such embodiments, the surface of the support material may be treated in order to improve the adhesion of the optical data storage media to the support. For example, the surface of the support material may be treated by corona discharge prior to applying the optical data storage media. Alternatively, an undercoating, such as a halogenated phenol or partially hydrolyzed vinyl chloride-vinyl acetate copolymer can be applied to the support material to increase the adhesion of the storage media thereto.

Generally speaking, the optical data storage media described herein can be prepared by blending the desired sensitizer, reactant, mediator (if desired) and polymer matrix. Proportions of these may vary over a wide range, and the optimum proportions and methods of blending may be readily determined by those of ordinary skill in the art. For example, the sensitizer may be present in concentrations of from about 0.01 weight % to about 90 weight %, and the reactant may be present in concentrations of from about 2 weight % to about 80 weight %, based upon the total weight of the optical data storage media.

### Test Methods

Optical data storage media can be independently characterized based on their photo-induced UV-vis absorption change in response to the radiation at the wavelength of interest. In the Examples below, the refractive index change is a result of the change in the absorption spectrum of the polymer matrix/reactant in response to the triplet-triplet energy transfer from the non-linear sensitizer. By monitoring change in the absorption spectrum upon actinic irradiation, in particular its dependence on the radiation intensity and/or fluence, one can characterize the efficiency of the triplet-triplet energy-transfer-mediated refractive-index change.

### Sample Preparation

Thin film samples with compositions as shown in Table 1 were prepared for photo-induced experiments as follows:

### EXAMPLE 1

Stilbene PCCD polymer (990 mg, copolymer of poly(1,4-cyclohexylidene cyclohexane-1,4-dicarboxylate) & poly(1,4-cyclohexylidene stilbene-4,4′-dicarboxylate):

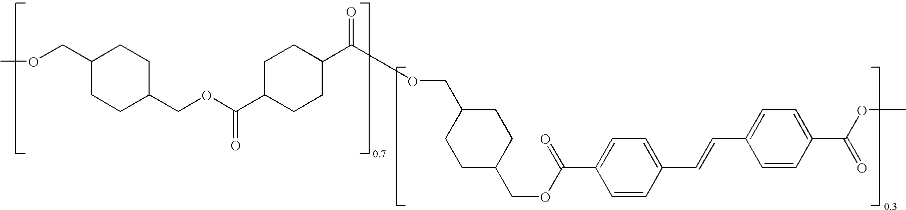

and InPc (Indium 2, 9, 16, 23-tetra-tert-butyl-29H-31H-phthalocyanine)dye (10 mg) were dissolved in tetrachloroethane (19 g). The solution was then filtered using 0.45 μm filter, and poured onto a 1 mm thick quartz slide mounted on a spin coater and spun at rate of 1500 rpm for 45 seconds. The sample was allowed to set up and dry on a hot plate maintained at 45° C. for 5 hours and at 75° C. overnight.

### EXAMPLE 2

A sample of stilbene PCCD polymer with ZnPc (Zinc 2,9,16,23 -tetra-tert-butyl-29H, 31H-phthalocyanine)dye (2 wt %) was prepared according to Example 1.

### EXAMPLE 3

PMMA (Polymethylmethacrylate, 910 mg) with trans-stilbene (80 mg) and InPc dye (10 mg) were dissolved in tetrachloroethane (13 g). The solution was then filtered using 0.45 μm filter. The solution was then poured onto a 1 mm thick quartz slide, mounted on a spin coater, and spun at rate of 1500 rpm for 45 seconds. The glass plate setup and dried on a hot plate maintained at 45° C. for 5 hours and at 75° C. overnight.

### EXAMPLE 4

A sample of trans-stilbene (8 wt %) in PMMA with InPc dye (1 wt %) and benzophenone (4 wt %) was prepared according to Example 3.

TABLE 1

| | | | | | | | | Ultimate Percent |
|---|---|---|---|---|---|---|---|---|
| Example | | | wt % of | | wt % of | | wt % of | Conversion of |
| no. | Polymer | Reactant | Reactant | Sensitizer | Sensitizer | Mediator | Mediator | Reactant (%) |
| 1 | Stilbene | t-Stilbene | 17 | InPC | 1.0 | None | 0 | 19.0 |
| | PCCD | polymer | | | | | | |
| | | bounded | | | | | | |
| 2 | Stilbene | t-Stilbene | 17 | ZnPC | 2.0 | None | 0 | 19.0 |
| | PCCD | polymer | | | | | | |
| | | bounded | | | | | | |
| 3 | PMMA | t-Stilbene | 8 | InPC | 1.0 | None | 0 | 14.0 |
| 4 | PMMA | t-Stilbene | 8 | InPC | 1.0 | Benzophenone | 4.0 | 41.0 |

### Optical Measurement

Photo-induced absorption change of the spin coated samples of Examples 1-4, shown in Table 1, were evaluated using output from 20ns (nanosecond) Nd:YAG laser with 532 nm wavelength as an excitation source and UV/Vis spectrometer to monitor the change of the absorption spectrum. In a typical experiment, an area 300 μm×300 μm of the samples prepared in Examples 1-4 was exposed to 532 nm wavelength beam with a diameter of 20 μm. The change in absorption spectrum of the polymer matrix/reactant (at 300 nm example 1 & 2 and 330 nm for example 3 & 4) after exposing was measured by UV-Vis spectrometer, utilizing a broad-band lamp probe beam focused to a ˜200um spot overlapping with the exposed region.

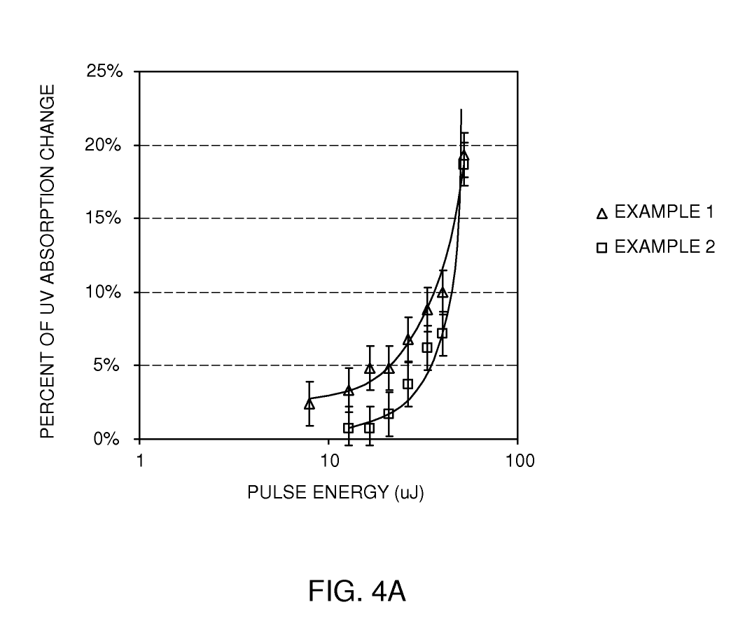

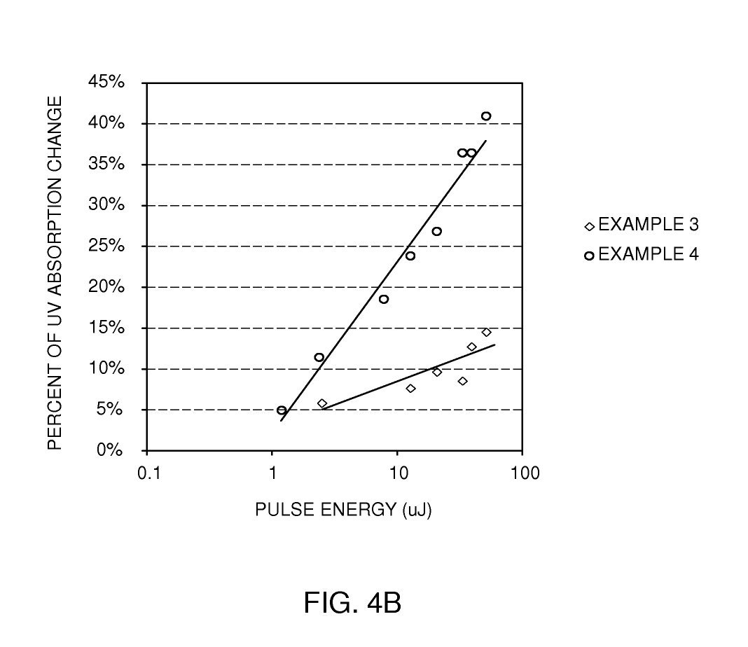

FIG. 4A shows the conversion efficiency of the polymer-bound stilbene samples (Examples 1 & 2) sensitized by InPc and ZnPc sensitizers. Both samples reach 19% conversion at high laser intensity.

In the mediator studies, benzophenone was utilized as mediator in the energy transfer from the InPc dye to the stilbene molecule. The triplet energy (T₁) of benzophenone is 74 kcal/mol, which matched well the T₂ energy level of the InPc dyes (˜88 kcal/mol) and T₁ energy level of stilbene (49 kcal/mol). FIG. 4B shows a photo-induced conversion measurement result for stilbene/InPc samples (Examples 3 & 4) with and without added 4 wt % of benzophenone. As seen from the graph, the effectiveness of the trans to cis isomerization increased by ˜1.5 in the presence of the benzophenone, which in turn should result in a greater refractive index change and therefore higher micro-hologram diffraction efficiency.

### EXAMPLE 5

### μ-Hologram Recording

### Sample Preparation

### EXAMPLE 5

Solution of PMMA (0.870 g) with trans-4-nitro-stilbene (80 mg), ZnPc (10 mg) and benzophenone (40 mg) was prepared using dichloroethane/methylene chloride solvent mixture (15 g, 2:8 v/v) as solvent. The solution was then filtered using 0.45 μm filter and then the solution was poured onto a glass rim (5 cm diameter) on a glass plate setup and dried on a hot plate maintained at about 45° C. for 5 hours and at about 75° C. overnight. After drying on a hot plate, the films were removed from the glass plates and vacuum dried at 60° C. for 6 hours.

TABLE 2

| Example | | | wt % of | | wt % of | | wt % of | |
|---|---|---|---|---|---|---|---|---|
| no. | Polymer | Reactant | Reactant | Sensitizer | Sensitizer | Mediator | Mediator | Comment |
| 5 | PMMA | t-4-nitro- | 8 | ZnPC | 1.0 | Benzophenone | 4.0 | Threshold sample |
| | | stilbene | | | | | | |

### μ-Hologram Recording Apparatus

Experimental demonstration of μ-hologram recording in the present threshold optical data storage media was performed using a micro-holographic static tester system. The system comprised a continuous-wave (CW) (<50mW) laser and a Q-switched (5 ns, <10 mJ/pulse) laser, both operating at 532 nm. The pulsed laser was used as the writing source, as the short duration of the light pulse allowed one to achieve light intensity values of hundreds of MW/cm² to several GW/cm² at the focal spot of such focused recording beam. The CW laser was used as the probe due to easier detection of the continuous light source. Both 532nm lasers have long coherence lengths (>1 m), which ensures high-contrast interference pattern at the sample without need of path length compensation if they are used for recording. The CW and pulsed laser beams were coupled into the same optical pass using polarization so that either of the beams can be used for recording or readout. Pulsed exposure was controlled via a fast mechanical shutter that operated synchronized to the pulsed laser cycle to allow a single or few multiple pulses to pass through toward the medium upon recording. The CW laser exposure was controlled with a fast shutter allowing pulses >2.5 ms when it was used for recording, and was continuously open when used for readout.

The recording of μ-holograms in the optical data storage media prepared in Example 5 was performed by two high-intensity counter-propagating pulsed recording beams focused and overlapped in the bulk of the recording medium to produce the intensity fringe pattern consisting of light and dark regions (fringes). The illuminated regions of the interference pattern undergo a photo-chemical change that results in a locally modified refractive index of the media, while the dark regions remain intact, thus creating a volume hologram. The present optical data storage media is sensitive to a high-intensity light and is relatively inert to the low-intensity radiation. The power of the recording beam was adjusted so that the light intensity near the focal region of the media is above the recording threshold (above which the photochermical change readily occurs), while remaining low outside the recordable region away from the focal spot of the beam, thus eliminating unintended material modification (recording or erasure).

During μ-hologram recording, the primary recording beam is split into the signal and the reference using a half-wave plate (λ/2) and a polarization beam splitter (PBS). The two secondary beams are steered to the sample in a counter-propagating geometry and are focused to overlap in the bulk of the optical data storage media by identical aspheric lenses with a numerical aperture (NA) of 0.4. The polarization of both beams is converted into circular polarization—with two quarter-wave plates to ensure that the beams interfere to create a high-contrast fringe pattern. The NA of the focused beams can be reduced by altering the size of the beam entering the lens and a NA of ˜0.22 was used in this experiment, which resulted in a beam waist radius (1/e2) of 0.76um, and a Rayleigh parameter of ˜5.5 μm in the medium. The sample and the signal beam lens are mounted on closed-loop three-axis positioning stages with 25 nm resolution. A position-sensitive detector on the reference side of the sample is used to align the signal lens for optimized recording.

A variable attenuator and the half-wave plate/PBS assembly were used to control the power level during recording and/or read-out. This allows the μ-holographic recording characteristics of the optical data storage media to be characterized as a function of the recording power and/or energy. This functional dependence distinguishes between a linear optical data storage medium/recording, where the strength of the recorded hologram is largely defined by the total amount of light energy received by the material, but is independent of the light intensity, and a threshold optical data storage medium, where the recording efficiency is highly dependent on the intensity of the light. In a linear medium, a small exposure results in a low-strength hologram, which gradually grows with higher exposures. In contrast, in a threshold medium, recording is only possible with the intensity exceeding the threshold value.

During read-out, the reference beam is reflected by the μ-holograms in the direction opposite to the incident beam. It is coupled out from the incident beam path using the quarter-wave plate and polarizer, and is collected on a calibrated photodiode in a confocal geometry to provide an absolute measure of the diffraction efficiency. By translating the sample with respect to the readout optics, it is possible to obtain a 3D profile of a micro-hologram diffraction response and evaluate dimensions of a micro-hologram.

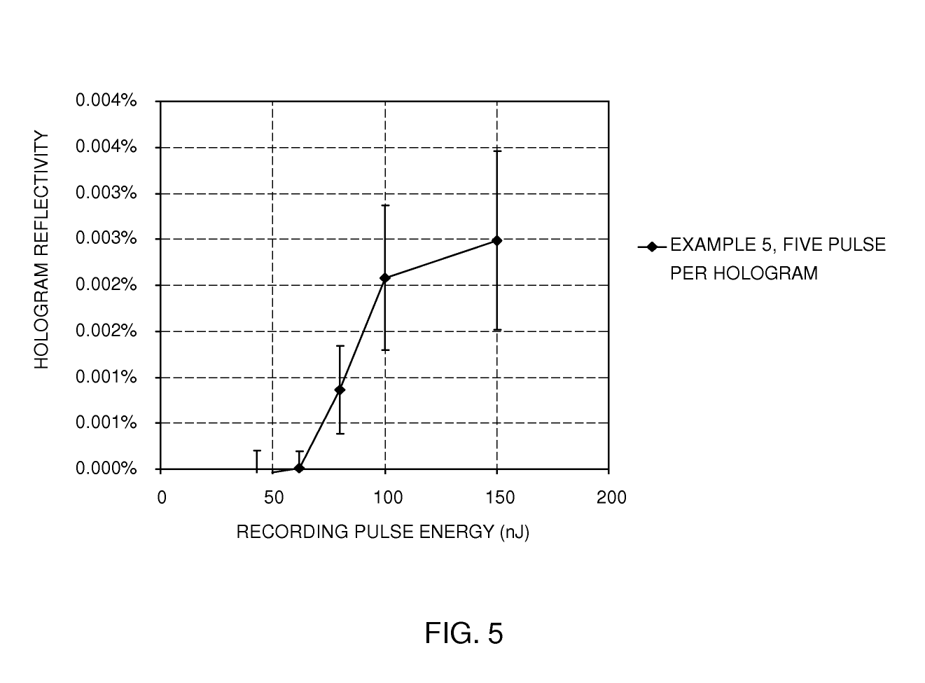

FIG. 5 shows an experimentally measured dependence of a μ-hologram reflectivity vs. recording pulse energy in the optical data storage media produced in Example 5. As shown in FIG. 5, once the recording energy is lower than the threshold value (˜60nJ/pulse), the recorded hologram reflectivity essentially becomes zero.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An optical data storage medium comprising:
A polymer matrix;
A reactant capable of undergoing a photochemical change upon triplet excitation, thereby causing a refractive index change; and
A non-linear sensitizer capable of absorbing actinic radiation to cause upper triplet energy transfer to said reactant.

2. The optical data storage medium of claim 1, wherein the medium is capable of storing microholographic data.

3. The optical data storage medium of claim 1, wherein the absorbance and/or refractive index of the medium changes in response to light having an intensity at least 2 orders of magnitude or more greater than ambient light.

4. The optical data storage medium of claim 1, further comprising a mediator capable of transferring energy between the non-linear sensitizer and the reactant.

5. The optical data storage medium of claim 4, wherein the mediator comprises acetophenone, dimethylphthalate, benzophenone, 9H-fluorene, biphenyl, phenanthrene, 1-napthonirile, and combinations of these.

6. The optical data storage medium of claim 1, wherein the reactant comprises a stilbene derivative, an indole derivative, or a combination of these.

7. The optical data storage medium of claim 6, wherein the reactant comprises a stilbene derivative further comprising trans-stilbene, trans-nitrostilbene, trans-methoxystilbene or combinations of these.

8. The optical data storage medium of claim 7, wherein the reactant comprises a pyridyl derivative further comprising (Z)-2-(2-(pyridine-2-yl)vinyl)-1H-indole.

9. The optical data storage medium of claim 6, wherein the reactant comprises a pyridyl stilbene derivative.

10. The optical data storage medium of claim 1, wherein the non-linear sensitizer comprises a sequential two-photon reverse saturable absorber.

11. The optical data storage medium of claim 10, wherein the non-linear sensitizer comprises a phthalocyanine dye.

12. The optical data storage medium of claim 11, further comprising a photostabilizer.

13. The optical data storage medium of claim 12, wherein the photostabilizer comprises bisdithiobenzil nickel.

14. The optical data storage medium of claim 1, wherein the polymer matrix comprises one or more poly(alkyl methacrylates), poly(alkyl acrylates), polystyrenes, polycarbonates, poly acrylates, poly(vinylidene chloride), poly(vinyl acetate), or combinations thereof.

15. The optical data storage medium of claim 1, wherein the reactant and non-linear sensitizer are distributed substantially homogenously throughout the polymer matrix.

16. An optical data storage medium for the bit-wise recording of microholographic data comprising:
A polymer matrix;
A reactant comprising stilbene capable of undergoing a photochemical change upon triplet excitation, thereby causing a refractive index change; and
A non-linear sensitizer comprising reverse saturable absorber capable of absorbing actinic radiation to cause upper triplet energy transfer to said reactant.

17. The optical data storage medium of claim 16, further comprising a mediator capable of transferring energy between the non-linear sensitizer and the reactant.

18. The optical data storage medium of claim 17, wherein the mediator comprises acetophenone, dimethylphthalate, benzophenone, 9H-fluorene, biphenyl, phenanthrene, 1-napthonirile, and combinations of these.

19. The optical data storage medium of claim 16, wherein the reactant comprises trans-stilbene, trans-nitrostilbene, trans-methoxystilbene or combinations of these.

20. The optical data storage medium of claim 16, wherein the reactant comprises a pyridyl stilbene derivative.

21. The optical data storage medium of claim 16, wherein the non-linear sensitizer comprises a phthalocyanine dye.

22. A method for optical data storage comprising:
Providing an optical data storage medium comprising a polymer matrix, a reactant capable of undergoing a photochemical change upon triplet excitation, thereby causing a refractive index change and a non-linear sensitizer capable of absorbing actinic radiation to cause upper triplet energy transfer to said reactant; and
Recording a microhologram in said optical data storage medium.
